(19) United States
(12) Patent Application Publication
(10) Pub. No.: US 2026/0252259 A1
(43) Pub. Date: Aug. 27, 2026

(54) SYSTEMS AND METHODS TO CONTROL DATA RETENTION BY SETTING PASS THROUGH VOLTAGE

(71) Applicant: Microchip Technology Incorporated, Chandler, AZ (US)

(72) Inventors: Salvatrice Scommegna, Cornate D'Adda (IT); Pitamber Shukla, San Jose, CA (US); Michele Cirella, Castelmassa (IT); Antonio Aldarese, Vimercate (IT)

(73) Assignee: Microchip Technology Incorporated, Chandler, AZ (US)

(21) Appl. No.: 19/246,303

(22) Filed: Jun. 23, 2025

Related U.S. Application Data
(60) Provisional application No. 63/761,289, filed on Feb. 21, 2025.

(51) Int. Cl. G06F 3/06

(52) U.S. Cl. CPC G06F 3/0655; G06F 3/0604; G06F 3/0679

(57) ABSTRACT

A data storage system includes a memory device, a memory including instructions stored thereon, and at least one processor. The memory device includes a block that may include a plurality of wordlines (WLs). The memory includes instructions stored thereon that, when executed by the at least one processor, cause the at least one processor to: identify a plurality of data retention temperatures determined for the block at a plurality of corresponding times; compute an adjusted pass-through voltage (Vpassr) based on the plurality of data retention temperatures; and perform a read operation at least in part by: applying a read voltage (Vread) to a selected WL of the plurality of WLs; and applying the adjusted Vpassr to one or more unselected WLs of the plurality of WLs.

### CROSS REFERENCE TO RELATED APPLICATIONS

The current patent application claims the benefit under 35 U.S.C. § 119(e) of the priority date of U.S. Provisional Application Ser. No. 63/761,289; titled “SYSTEM FIRMWARE ALGORITHM FOR PASS THROUGH VOLTAGE ADJUSTMENT FOR DATA RETENTION CONDITION”; and filed Feb. 21, 2025. The Provisional Application is hereby incorporated by reference, in its entirety, into the current patent application.

### TECHNICAL FIELD

Various examples of the present disclosure relate to systems and methods for adjusting a pass-through voltage (Vpassr) to compensate for data retention effects.

### BACKGROUND

“Data retention” in flash devices and flash memory components, for example, NOT-AND (NAND) flash devices, refers to the ability of the device or memory to retain stored data over time without corruption. For example, data retention may be described in relation to the amount of time that data can be reliably stored at a specific address location without corruption, degradation or loss. The duration of data retention is influenced by various factors, including temperature, the number of program/erase (P/E) cycles, and the type of NAND flash technology used.

This background discussion is intended to provide information related to the present disclosure which is not necessarily prior art.

### SUMMARY

According to various examples of the present disclosure, a data storage system includes a memory device, non-transitory computer readable media storing instructions thereon, and at least one processor. The memory device includes a block having a plurality of wordlines (WLs). The at least one processor executes the instructions, which causes the at least one processor to: identify a plurality of data retention temperatures determined for the block at a plurality of corresponding times; compute an adjusted pass-through voltage (Vpassr) based on the plurality of data retention temperatures; and perform a read operation at least in part by: applying a read voltage (Vread) to a selected WL of the plurality of WLs; and applying the adjusted Vpassr to one or more unselected WLs of the plurality of WLs.

According to various examples of the present disclosure, a computer-implemented method includes: identifying a plurality of data retention temperatures determined for a block of a memory device of a data storage system at a plurality of corresponding times; computing an adjusted Vpassr based on the plurality of data retention temperatures; and performing a read operation at least in part by: applying a Vread to a selected WL of a plurality of WLs of the block; and applying the adjusted Vpassr to one or more unselected WLs of the plurality of WLs.

According to various examples of the present disclosure, non-transitory computer readable media having instructions stored thereon are provided. When executed by at least one processor, the instructions cause the at least one processor to: identify a plurality of data retention temperatures determined for a block at a plurality of corresponding times; compute an adjusted Vpassr based on the plurality of data retention temperatures; and perform a read operation at least in part by: applying a Vread) to a selected WL of a plurality of WLs of the block; and applying the adjusted Vpassr to one or more unselected WLs of the plurality of WLs.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current technology will be apparent from the following detailed description of the various examples and the accompanying drawing figures.

### BRIEF DESCRIPTION OF THE DRAWINGS

FIG. 1 illustrates an example system for implementing an adjusted pass-through voltage (Vpassr) to compensate for data retention;

FIG. 2 illustrates an example computing system configured to perform operations in accordance with the various examples of the present disclosure;

FIG. 3A illustrates an example non-volatile memory (NVM) media of the system of FIG. 1;

FIG. 3B includes a table illustrating a logical layout of at least a portion of an NVM media of the memory device of FIG. 1;

FIG. 3C is a block diagram of additional hierarchy of at least a portion of an NVM media of the memory device of FIG. 1;

FIG. 4 illustrates an example of a physical memory block of the NVM media of FIG. 3A;

FIG. 5 shows block diagrams of a memory structure within a memory block of NVM media and graphs plotting threshold voltage against, respectively, number of cells and log of string current, in each case illustrating different states of a single-level cell (SLC);

FIG. 6 illustrates an example of a graph that plots a number of cells versus threshold voltage across multiple pages, highlighting the different programmed states of a triple-level cell (TLC) memory cells, alongside a schematic block diagram depicting the memory structure within blocks; and

FIG. 7 illustrates an example method for computing the Vpassr for various wordlines.

Unless otherwise indicated, the figures provided herein are meant to illustrate features of examples of this disclosure. These features are believed to be applicable in a wide variety of systems comprising one or more examples of this disclosure.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In addition, use of “a” or “an” are employed to describe elements and components of the embodiments herein. This is done merely for convenience and to give a general sense of the description. Uses of “a” or “an” in this description, and the claims that follow, should be read to mean at least one unless plainly stated otherwise.

In various examples of the present disclosure, data storage systems may be connected to host systems by wired or wireless means. In various examples, multiple data storage systems may be connected to a single host system. In various examples, a data storage system may be connected to more than one host system, such as in a multi-tenant environment, without limitation. The host system may be configured to send data write requests and data read requests to a data storage system. The data storage system may include a memory device and a controller. The memory device may store data, for example, data transmitted or sent via a data write request by the host system. The controller may be operable to manage storage and retrieval of data to and from the memory device. The controller may process the data and issue commands to the memory device for storing the data in the memory device. The host system may send a data read request to the data storage system. The data read request may indicate data to be retrieved from the memory device and sent back to the host system. The controller may process the data read request, retrieve the data from the memory device, process the retrieved data, and send the retrieved data to the host system. The data may be read from the memory device using a threshold voltage.

In various examples, the memory device may include a plurality of non-volatile memory (NVM) media (e.g., NAND-based memory media) for data storage. In various examples, the NVM media may include chip enable (CE) ports which may also be referred to as “targets.” Examples may be used in single-level cell (SLC) systems, multi-level cell (MLC) systems, triple-level cell (TLC) systems, quad-level cell (QLC) systems, and penta-level cell (PLC) systems, without limitation. Applications may include consumer hard drives, high performance computing (HPC), data transfer for AI, machine learning (ML) based firmware (FW), and data center solutions (DCS), without limitation.

In various examples, the data write request from the host system causes the data to be stored in various blocks (or memory cells of a block) of the data storage systems, such as NAND blocks of a NAND flash memory. A block may belong to any of the physical blocks, virtual blocks, or sub-blocks of either the physical or virtual blocks. Each block may include a set of pages, a set of virtual wordlines (VWLs), and each VWL may include a plurality of wordlines (WLs).

Over time, each NAND block may undergo data retention, which may be an intrinsic characteristic of the NAND flash memory. As used herein, data retention in NAND flash memory refers to the duration/period during which data stored in specific NAND flash memory locations remains readable without errors or corruption. Data retention may depend on factors such as program/erase cycles (P/E cycles), electron leakage through blocking oxide or tunnel oxide layers from a charge trap layer or a floating gate layer, operating temperature of flash memory cells and flash die (chip) of the NAND flash memory, and the type of NAND technology used (e.g., SLC, MLC, TLC, QLC, and PLC, without limitation).

Due to data retention, the voltage thresholds of memory cells (or programmed cells) may shift over time, for example between the programmed time and the read operation (i.e., the data read request). For example, voltage thresholds may shift downward for memory cells as electrons are leaked from a charge trap layer or a floating gate layer and data retention decreases. This may result in read latency issues, data reliability concerns over the NAND flash memory, read errors, and data corruption due to high read errors, and may require multiple read retries, which increases power consumption and is time consuming.

Alternative methods and systems may use read recovery schemes, such as best-read-positioning (BRP) or read-retry (RR) algorithms, which are different levels of correction techniques aimed at reducing data retention effects. Nonetheless, such techniques lead to read latency and are time-consuming.

To address data reliability concerns, and reduce read latency and data corruption within the block during or at the time of the read operation, there is a need to control for data retention across all WLs and pages by setting an adjusted Vpassr based on the extent of data retention, for example by reducing the default Vpassr in view of (e.g., in proportion to) the extent of data retention.

In various examples, the present disclosure provides systems and methods for determining and applying an adjusted Vpassr to unselected WL(s) of a block in connection with performance of a read operation on a selected WL of the block to mitigate effects of reduced data retention such as read errors. The adjusted Vpassr helps reduce string current (Icell) related to read cells and reduce threshold voltage (Vt) mismatch due to reduced data retention, enhancing the quality of service (QoS) of the data storage system.

In various examples, the controller of the data storage system (e.g., NAND flash memory) may be configured to measure or otherwise identify programming time and operating temperatures. In various examples, measuring or identifying the programming time and operating temperature may be performed in connection with the host system's data write request. In various examples, the operating temperature may correspond to the temperature of the memory cells, the flash die (the internal temperature of the chip) of the NAND flash memory, or the controller of the data storage system, without limitation. The controller may be configured to continuously or periodically monitor and identify the data retention temperature of each block in the data storage system. Periodic monitoring and sampling of data retention temperatures in a block may occur at fixed intervals or with variable frequency. Each measurement or identification of a data retention temperature may be associated with a timestamp and/or with the corresponding sampling interval, resulting in identification of a plurality of data retention temperatures over time (e.g., in a time series).

In various examples, the plurality of data retention temperatures is identified over a timelapse period beginning with a program or write operation and ending with a read operation. For example, the plurality of data retention temperatures identified over the timelapse period may include a program temperature (associated with the write operation), one or more sampled or otherwise identified temperatures after the write operation, and a read temperature (associated with a read request). The one or more temperatures sampled or identified between write and read operations may be associated with regular or variable frequency intervals. One of ordinary skill will appreciate that other data retention temperatures may be measured, sampled or otherwise identified or determined, and may be relevant to determination of data retention and of an adjusted Vpassr, within the scope of various examples.

In various examples, the monitored and identified information may be stored in the memory device of the data storage system. For example, monitored and identified information such as a plurality of data retention temperatures, a plurality of corresponding measurement or sampling times or timestamps, and/or one or more Vpassr offsets or adjustments (or corresponding adjusted Vpassr(s)) computed for each such sampling interval or for the entire timelapse period, may be stored within the memory device.

The information discussed above may be organized in a lookup table. As discussed above, the information may be stored as aggregated, averaged, or accumulated values.

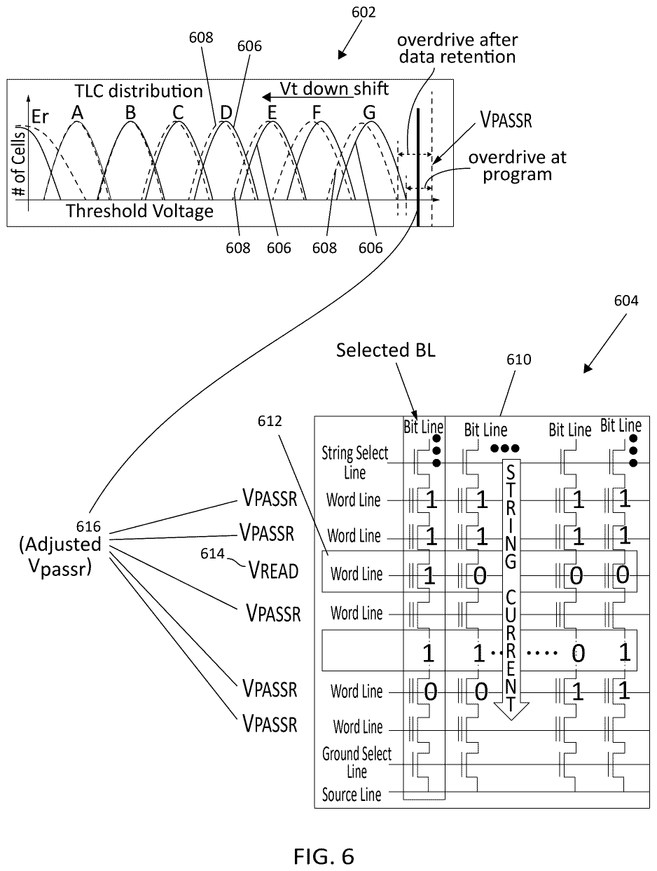

In various examples, the controller may be configured to determine an adjusted Vpassr based on an overdrive effect or shift resulting from reduced data retention. More particularly, the upper portion of FIG. 6 illustrates a graph plotting number of cells versus voltage threshold (Vth) across multiple pages of example TLC memory cells and highlights different programmed states of TLC memory cells. An uppermost Vt distribution of the uppermost programmed state (shown on the righthand side of the graph) may provide a landmark for determining a default Vpassr. That is, the default Vpassr may be set at a value offset from the point of intersection at which the Vt of the uppermost programmed state crosses the x-axis of the graph. This offset may be referred to as an “overdrive.” Reduced data retention may cause the point of intersection to shift left (reduced Vt), correspondingly causing the offset or gap between the point of intersection and the default Vpassr to widen. The controller may be configured to determine the degree of such shift(s), based on the data retention temperatures, at one or more points during the timelapse period. For example, a shift may be calculated corresponding to each time interval between the data retention temperature samples or intervals or may be computed periodically to encompass shift(s) resulting from multiple data retention temperature samples or intervals (or all of the data retention temperature samples of the timelapse period). The shift(s) may be used to compute corresponding adjusted Vpassr(s).

In various implementations, the adjusted Vpassr may be computed in response to detecting a read operation initiated by the host system. The read operation includes applying Vread (read voltage) and a Vpassr to unselected WLs. In various examples, the adjusted Vpassr may be computed by adjusting the default Vpassr based on the overdrive effect. In various examples, the adjusted Vpassr may be determined by referencing the lookup table or similar database structure storing the information discussed in more detail above (e.g., the plurality of data retention temperatures and corresponding timestamps and/or considering corresponding intervals).

In various examples, the adjusted Vpassr is computed. In various implementations, the adjusted Vpassr may be computed by applying mathematical equations or formulations, for example the Arrhenius equation, using values for or that may be equivalent to the data retention temperatures within the timelapse period. The computation of the adjusted Vpassr may essentially estimate a loss in data retention based on the temperature profile over time of the block following the corresponding write or program operation. The number of intervals or frequency of sampling of data retention temperatures may contribute to the accuracy of the estimate (e.g., where more frequent sampling provides greater accuracy). In various examples, the computation may also consider other factors which may influence data retention, such as the order of temperature fluctuations (cold then hot, or hot then cold), the severity of temperature fluctuations, the frequency of temperature fluctuations, and/or other factors.

As discussed in more detail above, in various implementations, adjustments to or adjusted Vpassr(s) may be incrementally calculated throughout a timelapse period. At or responsive to a read request, the plurality of accumulated adjustments computed and stored for the timelapse period may be summed or otherwise combined to determine the adjusted Vpassr for the read operation. Also or alternatively, an adjusted Vpassr may be computed at each interval of a timelapse period, such that, responsive to the read request, the most recent computed adjusted Vpassr may simply be retrieved for the read operation. Also or alternatively, and as discussed in more detail above, the data retention temperatures and timestamps or intervals may be stored (in discrete or averaged values, for example) throughout the timelapse period and retrieved, responsive to the read request, to compute the adjustment and/or adjusted Vpassr for the read operation.

The adjusted Vpassr determined for application to one or more unselected WL(s) may further be used to compute additional Vpassr values for application to other unselected WLs. In various implementations, the controller may perform various techniques or operations to determine or forecast data retention shift and/or additional adjusted Vpassr(s) for other WLs based on the adjusted Vpassr computed from the data retention temperatures. The operations may include reliance on trained machine learning (ML) model(s) or predictive algorithms, without limitation. For example, an adjusted Vpassr computed for WL thirty (WL 30) of a block may be used to estimate a different data retention shift for WL fifty (WL 50) and to compute another (second) adjusted Vpassr for application to WL 50 in connection with a read operation. In various examples, additional adjusted Vpassr(s) computed from the initial adjusted Vpassr (determined from data retention temperatures) may be determined based, for example, on differences in physical location of the unselected WLs within the block.

Accordingly, the controller may be configured to perform the read operation by applying Vread to the selected WL and the adjusted Vpassr to one or more of the unselected WLs. In various examples, the adjusted Vpassr may typically be lower than the default Vpassr and may also be greater than the highest Vt of all programmed cells in the same BL following shift(s) of the distribution due to reduced data retention.

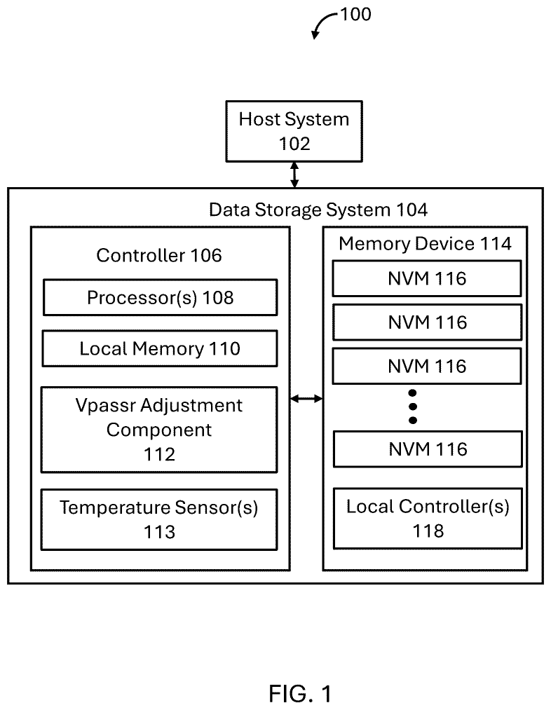

FIG. 1 illustrates an example of a system 100 that includes a host system 102 and a data storage system 104. The data storage system 104 includes a controller 106 and a memory device 114. The controller 106 includes a processor 108, a local memory 110, a Vpassr adjustment component 112, and one or more temperature sensors 113. The memory device 114 includes a plurality of non-volatile memory (NVM) media 116 and one or more local controller(s) 118. In various examples, the local controller(s) 118 may include one or more temperature sensors for measuring temperature of the memory device 114 and/or one or more of the NVM 116.

In various examples, a read or write request may be received from the host system 102 via a peripheral component interconnect express (PCIe) interface that connects the data storage system 104 to servers or CPUs. PCIe is a standardized interface for motherboard components. In various examples, the data storage system 104 may be connected to the host system 102 by wired or wireless means (e.g., through a communications network). The data storage system may be connected to more than one host system, such as in a multi-tenant environment, without limitation.

The controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random-access memory (SDRAM), without limitation. In various examples, the local memory 110 may also include double data rate (DDR), direct media interface (DMI), block random access memory (BRAM), enhanced direct memory access (eDMA), static random-access memory (SRAM), without limitation.

When a data request is received from the host system 102, the controller 106 references the L2P mapping table to determine the PBA within the NVM media 116 corresponding to a desired LBA. Once the PBA is determined, the controller 106 accesses the appropriate NVM media 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the memory device 114 may support a direct memory access (DMA) operation enabling data to be written from the host system 102 directly to the NVM media 116 and read from the NVM media 116 directly to the host system 102. Certain commands may be issued to the controller 106 or the local controller(s) 118 using the host command layer, or non-volatile memory express management interface (NVMe-MI).

In various examples, the data storage system 104 may be a solid-state drive (SSD), and the NVM media 116 may be NAND-based flash memory. It would be appreciated by one of the ordinary skill in the art that other memory devices (e.g., NOR flash memory, random access memory, and the like) may be utilized in the various examples described herein without departing from the spirit of the present disclosure.

In various examples, the controller 106 may receive a write request from the host system 102. The write request may include user data to be written to one or more of the NVM media 116 of the memory device 114. The user data may include, for example, media (e.g., photos, videos, and/or audio), system information data, application data, sensor data, document data, recordkeeping data, machine learning/artificial intelligence data, gaming system data, data pertaining to internal operations of the host system, and the like, without limitation.

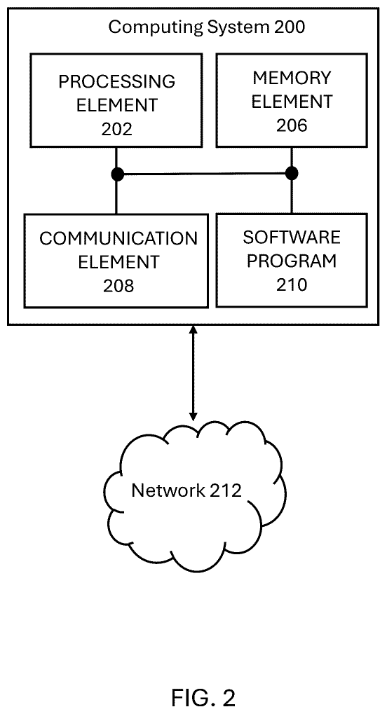

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1), a data storage system (e.g., the data storage system 104 of FIG. 1), and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206. In various examples, the software program 210 may include instructions for performing operations of the Vpassr adjustment component 112 discussed with reference to FIG. 1.

The communication network 212 generally allows communication between the computing system 200 and another computing device, such as between a remote host system (e.g., the host system 102), a local host system, and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain examples, the communication element 208 may also be coupled with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In various examples, the memory element 206 stores the software applications/program 210. The memory element 206 may also store the lookup table containing various temperature readings and voltage values associated with the block(s) before and after data retention. In various examples, the memory element 206 may include a first memory component (e.g., the local memory 110 of FIG. 1) and one or more SSDs (e.g., the memory device 114 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

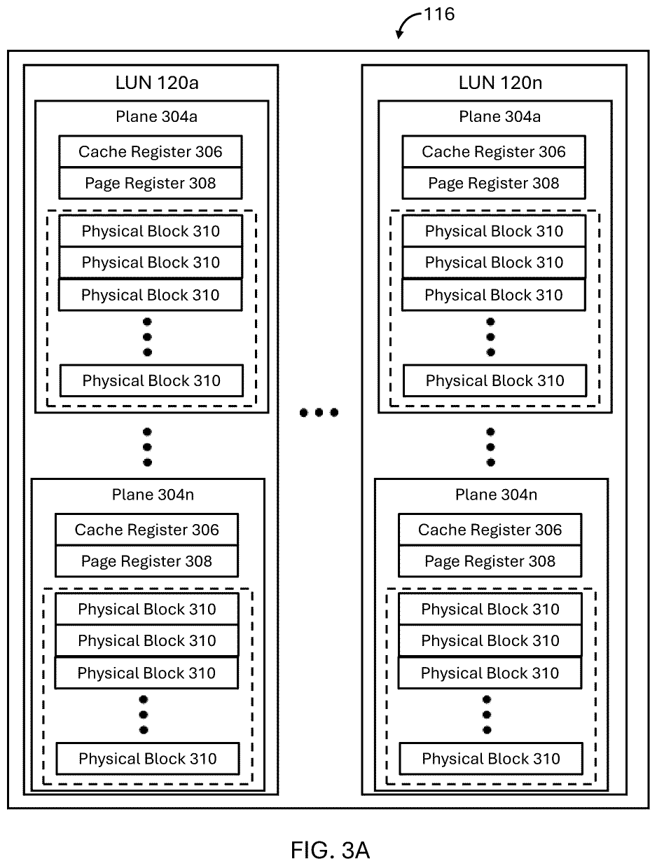

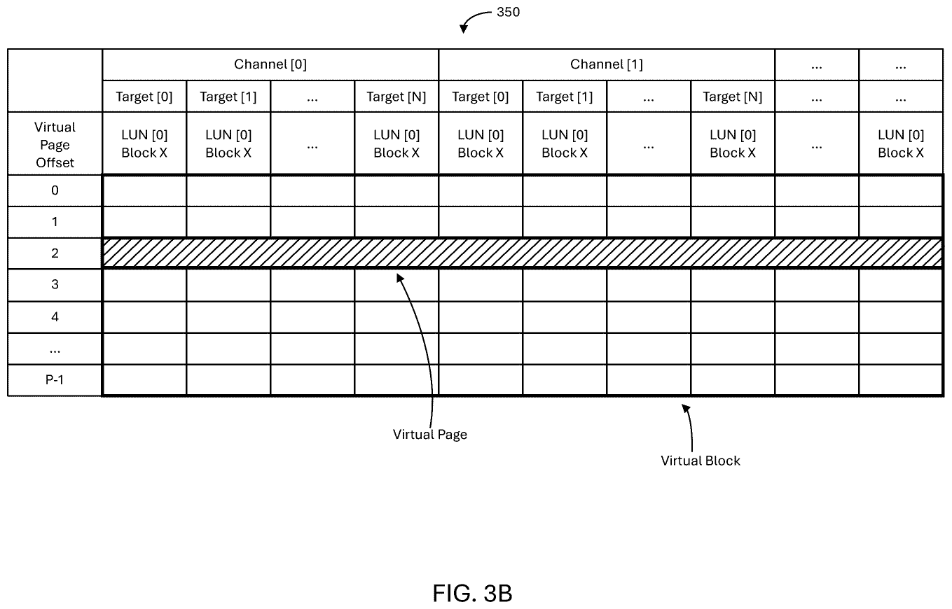

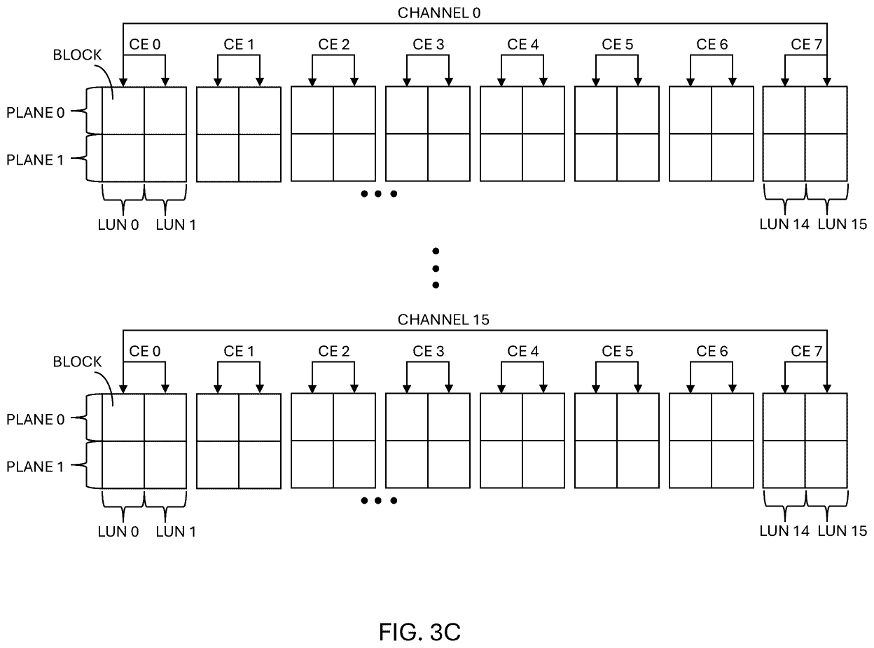

Turning to FIG. 3A, the NVM 116 may respectively include a plurality of LUNs. As illustrated, the NVM 116 includes LUNs 120a, . . . 120n, where ‘a’ and ‘n’ are integers. As such, each NVM 116 may include, for example, two (2), four (4), six (6), eight (8), or more LUNs, without limitation. For example, if the NVM 116 of FIG. 3A were to include sixteen (16) LUNs, LUNa might be represented as LUN 0 and LUNn might be represented as LUN 15. An example of an NVM including sixteen (16) LUNs (e.g., LUN 0 through LUN 15) is described in more detail in connection with FIG. 3C. Each LUN 120a, . . . 120n may include a plurality of planes 304a, . . . 304n, again where ‘a’ and ‘n’ are integers. Each LUN 120a, . . . 120n may include, for example, four (4), six (6), eight (8), or more planes, without limitation. Accordingly, if a particular LUN (e.g., LUN 0 of FIG. 3C) were to include, as a non-limiting example, two (2) planes, those planes may be represented as plane 0 and plane 1 (e.g., as seen in LUN 0 of FIG. 3C).

Each plane may include a cache register 306, a page register 308, and a plurality of physical memory blocks 310. In various examples, the controller 106 may write incoming data to more than one NVM 116 in parallel. The NVM 116 may write incoming data to more than one LUN in parallel.

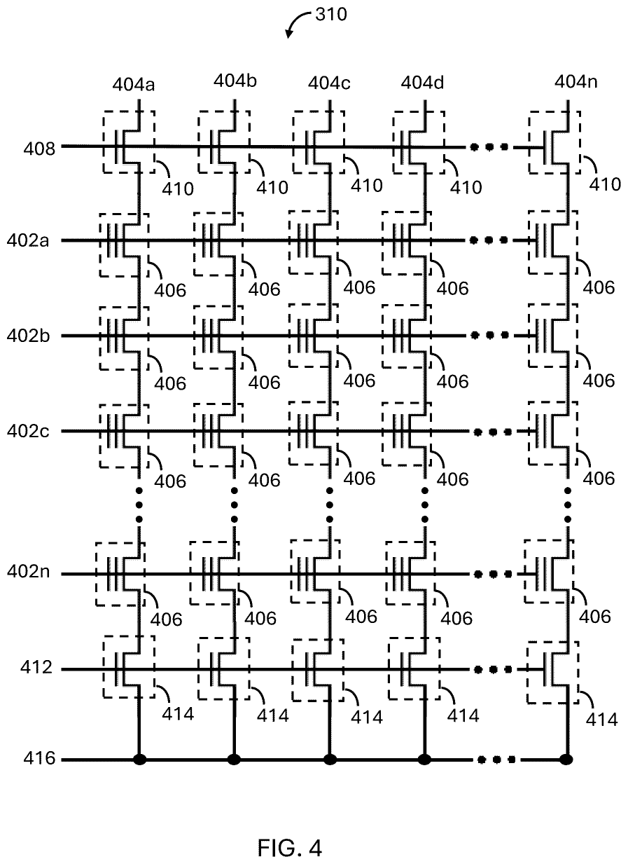

When data is written to or retrieved from the NVM 116, the data may be temporarily stored in one of the cache register 306 and/or the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

Returning to FIG. 3A, in various examples, the physical blocks 310 may be organized into VBs. A VB may include one physical block from each plane of each LUN of each NVM 116 of the memory device 114. Each VB may include a set of virtual wordlines (VWL). Each VWL may include a set of WLs (e.g., a VWL may include one (1) WL from each physical block of a VB). In various examples, the data processing and programming operations of this disclosure may be performed on a VB/VWL basis. Also or alternatively, the data processing and programming operations may be performed on a physical block/WL basis without departing from the spirit of the present disclosure.

Referring to FIG. 3B, a table 350 illustrates a first logical layout of at least a portion of the NVM 116 of the memory device 114. The table 350 includes a plurality of columns and a plurality of rows. Headings for the columns include a plurality of channels, with each channel including a plurality of targets, and each target including a LUN and a block. Labels for the rows include a plurality of virtual page offsets. Each cell of the table 350 represents one physical block of data storage, whereas all of the cells shown in the table 350 represent one VB of data storage, which is equal to one hundred twenty-eight (128) physical blocks of data storage. One row of cells in the table 350 represents a virtual page, which may correspond to a VWL.

FIG. 3C illustrates a hierarchical diagram of at least a portion of an NVM media, in accordance with the present disclosure. In various examples, FIG. 3C may illustrate the NVM 116 of FIG. 3A, which in turn is a more detailed view of the NVM 116 included in the memory device 114 of the data storage system 104 of FIG. 1. FIG. 3C depicts a plurality of blocks (e.g., the physical blocks 310 of FIG. 3A described above) of data storage configured in an array. All of the blocks in a row, which in this example includes sixteen (16) blocks, form a plane of data storage. As illustrated, a plane may span multiple CEs/CE lines (e.g., as Plane 0 of Channel 0 spans all sixteen (16) CE lines comprising the eight (8) CEs that are included in Channel 0). Two (2) blocks in a column (e.g., corresponding to/controlled by a CE line) form one (1) LUN, and two (2) LUNs, (e.g., LUN 0 and LUN 1) correspond to a CE (e.g., CE 0). Each of the sixteen (16) LUNs included in a channel (e.g., Channel 0) has a respective one of a plurality of CE lines (e.g., the left or right CE line comprising CE 0 through CE 7) electrically connected thereto, wherein each CE line receives a respective one of a plurality of CE signals. In addition, each CE line enables or disables a respective one of the LUNs (e.g., the left CE line of CE 0 may enable/disable LUN 0 and the right CE line of CE 7 may enable/disable LUN 15). Two (2) planes and eight (8) CEs form or correspond to a respective one of a plurality of channels, CHANNEL 0 through CHANNEL 15. In the illustrated exemplary diagram of a data storage system/device, there are two (2) planes associated with each LUN×two (2) LUNs per CE×eight (8) CEs per channel×sixteen (16) channels, resulting in 512 total blocks of data storage within the illustrated data storage device/system 104.

The data storage device/system may take the form of a physical board, such as a printed circuit board or flexible circuit board, or a card of data storage, and, according to the present disclosure, may be the data storage system 104 of FIG. 1. It will be appreciated that: more or fewer than two (2) planes may be associated with a LUN, more or fewer than two (2) LUNs may be included in/associated with a CE, more or fewer than eight (8) CEs may be included in/associated with a channel, and that more or fewer than sixteen (16) channels may be included/associated with a data storage system/device.

Turning to FIG. 4, each of the physical blocks 310 includes a plurality of wordlines (WLs) 402a, 402b, 402c, . . . 402n, a plurality of bit lines (BLs) 404a, 404b, 404c, 404d . . . 404n, a plurality of cells 406, a string select line 408, string select transistors 410, a ground select line 412, ground select transistors 414, and a source line 416. In various examples, a page may be defined as a row of cells connected to the same WL (e.g., the cells 406 connected to the WL 402a are collectively referred to as a page). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block basis.

Generally, each WL is an electrical conductor that is electrically connected to control gates of the cells in a respective row of cells. Each WL may convey an electronic signal that, according to its voltage level, selects a row (or page) of cells. (Each WL 402a, 402b, 402c, . . . 402n may be drawn as a horizontal line shown in FIG. 4.) When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electrical conductor that is electrically connected to the drains of cells in a column of cells. Each BL may convey an electronic signal that, according to its voltage level, may enable data transfer to and from the cells of a selected WL during read and write operations. (Each BL 404a, 404b, 404c, 404d . . . 404n may be drawn as a vertical line shown in FIG. 4.) During a read operation, the voltage on the BL reflects a state of the selected cell(s). Accordingly, the voltage and/or current of the BL may be measured and/or determined to determine the value of the data in the selected cells.

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402a, 402b, 402c, . . . , 402n may be SLC wordlines, MLC wordlines, QLC wordlines and/or PLC wordlines, without limitation. In an example, a TLC wordline may include a lower page, a middle page, and an upper page. The lower page, middle page, and upper page may correspond to a page including a row of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

The string select line 408 is an electrical conductor that is electrically connected to the gates of the string select transistors 410. The string select line 408 may convey an electronic signal that, according to its voltage level, selects one or more of the string select transistors 410. A BL bias voltage may be supplied to one or more of the BLs 404a, 404b, 404c, 404d, . . . 404n via the string select line 408. Similarly, the ground select line 412 is an electrical conductor that is electrically connected to the gates of the ground select transistors 414. The ground select line 412 may convey an electronic signal that, according to its voltage level, selects one or more of the ground select transistors 414.

The string select transistors 410, when activated (e.g., by receiving a BL bias voltage), may connect a string (or column) of cells 406 to a corresponding one of the bitlines 404a, 404b, 404c, 404d, . . . 404n. The ground select transistors 414, when activated, may connect a string (or column) of cells 406 to the source line 416. The source line 416 is an electrical conductor that is electrically connected to the sources of the cells 406. The source line 416, in turn, may connect the string of cells to a common ground (or reference) voltage. The source line 416 may be connected to a sense amplifier (not shown), which may measure a string current (Icell) and/or voltage of the activated cells 406, thereby determining a value of the data stored in the activated cells 406.

Generally, a read voltage threshold may correspond to a reference voltage used when reading data from a cell. During a read operation, a read voltage may be applied to a WL corresponding to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

Broadly, a Vpass is a voltage that passes directly through a circuit, from input to output, as if there were zero (0) impedance in the circuit (e.g., as if a wire were shorting the input to the output). Application of a Vpass may ensure unselected WLs included in the block(s) of memory device receiving the Vpass are “ON,” or operating at the value of the applied Vpass. For instance, if a Vpass of eight (8) volts (V) were to be applied to a memory device, then the memory device would be considered “ON” if the device were operating at 8V. Generally, a Vpass that is applied to one or more unselected WLs of a block of a memory device that is being subjected to a read operation may be referred to as Vpass-read (or “Vpassr”). Application of a Vpassr may enable data from one or more cells of a selected WL (e.g., the WL that is being or about to be subjected to a read operation) to be transmitted via the bit lines of the block that is the target of the read operation.

Returning to FIG. 1 the Vpassr adjustment component 112 may, in connection with a read operation, be configured to compute or otherwise identify or determine an adjusted Vpassr for application to one or more of the unselected WLs of a block while a Vread is applied to a selected WL of the block. The computation and application of the adjusted Vpassr may be performed for a single block or across multiple blocks, either on a VB basis or physical block basis, as discussed in more detail below.

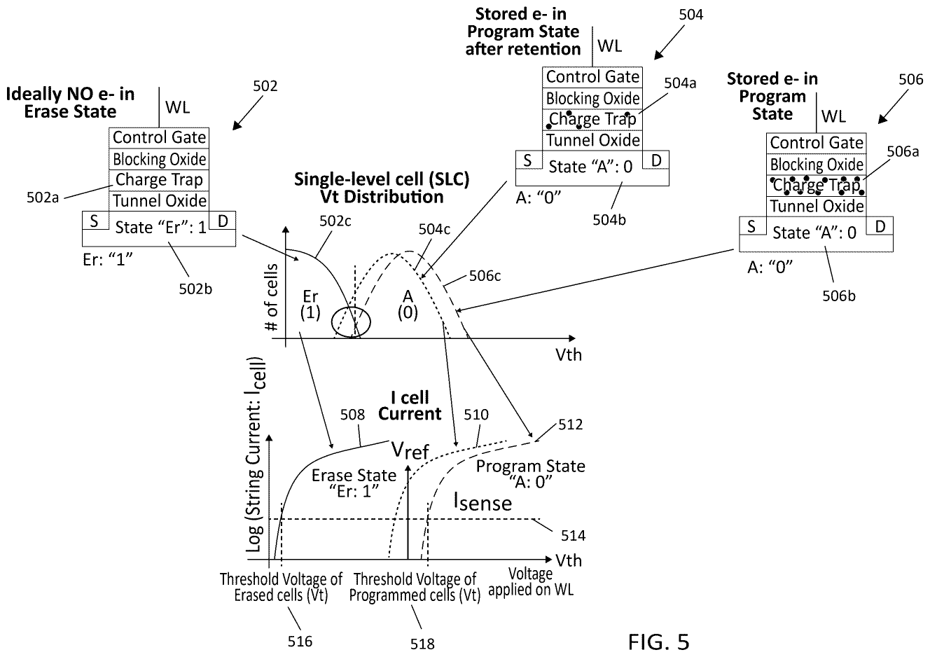

Uppermost portions of FIG. 5 show schematic block diagrams of a memory structure within the data storage system. Middle and lower portions of FIG. 5 illustrate, respectively, a graph that plots a number of cells versus Vth for an SLC having erase and programmed states and a graph that plots log of string current (Icell) versus voltage applied to a WL for the erase and programmed states. Memory cell diagrams 502, 504, and 506 represent different states of the SLC on the WL. Specifically, SLC 502 corresponds to the erased state, SLC 506 to the programmed state, and SLC 504 to the programmed state after data retention loss.

The SLC cell illustrated in the diagrams of FIG. 5 includes a control gate, blocking oxide, charge trap (502a, 504a, 506a), tunnel oxide, state region (502b, 504b, 506b), source(S), and drain (D). Before programming the memory cells on the WL, the charge trap 502a typically contains no electrons, resulting in a logic one (i.e., “1”), referred to as the “Erase State 1” (Er: “1”), which is the default state of the cells. Upon programming the memory cells, electrons are added to the charge trap (see 506a), creating the programmed state, where the bit value becomes “0” (A: “0”). Over time, due to data retention effects, electrons may leak from the charge trap (see 504a), for example through the blocking or tunnel oxide. Even after such leakage, the bit value typically remains “0”, representing the programmed state after data retention reduction (still denoted as A: “0”).

As noted above, the erased and programmed states, both before and after data retention, are first plotted using Gaussian curves with the number of memory cells on a vertical axis (Y-axis) against their Vth on a horizontal axis (X-axis). The erased state “Er (1)” is shown as waveform 502c, while the programmed state “A (0)” is illustrated with waveforms 506c (before data retention effects) and 504c (after data retention effects). Due to data retention effects, the Vt distribution for the programmed state undergoes a down shift (i.e., shifts to the left) along the X-axis, from 506c to 504 c, indicating a lower Vt compared to the distribution before data retention effects.

The erased and programmed states, both before and after data retention, are also plotted using the log of Icell on a vertical axis (Y-axis) against their Vth on a horizontal axis (X-axis) indicating voltage applied on WL. Before programming the memory cells, the erased state corresponds to logic one, represented as “Er: 1,” as illustrated by current curve 508. In the erased state, the memory cells may have a Vt 516, which is lower than a reference voltage (Vref). Sense current (Isense) 514 is also illustrated. After programming, the memory cells enter the programmed state, corresponding to logic zero, represented as “A: 0.” The programmed state has a higher Vt 518, above Vref, as shown by curve 512. Due to the data retention effect, the Vt distribution in the programmed state may shift toward the erased state (low Vt), as shown by curve 510, where Vt falls below Vref. This makes it harder for a sensing circuit to distinguish between the data states during a read operation, thus reducing the reliability of the read process.

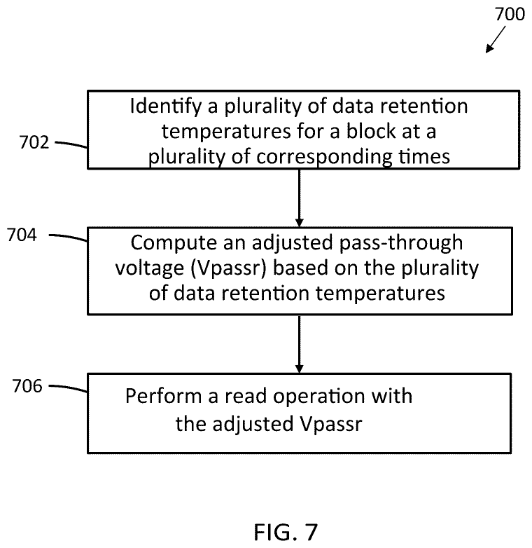

To mitigate the data retention effects, an adjusted Vpassr is computed as described with reference to FIGS. 6-7.

FIG. 6 illustrates a graph 602 that plots a number of cells versus Vth across multiple pages, highlighting different programmed states of TLC memory cells, alongside a schematic block diagram 604 depicting the memory structure within the memory device. FIG. 6 shows an example of an approach for applying the adjusted Vpassr to unselected WLs.

With reference to the plot 602, the Vt distribution for the TLC memory cells may be shown as Gaussian distributions corresponding to various programmed states. For example, the distribution includes seven programmed states: A, B, C, D, E, F, and G. The lowest state may correspond to the erased state (denoted as “Er”), which is associated with the lowest Vt of the TLCs. A highest programmed state may correspond to the G-state, associated with the uppermost distribution of Vt. The intermediate states are A, B, C, D, E, and F. The intermediate states are generally associated with Vt(s) that lie between the erased state and the G-state, though the low end of the A-state distribution and the high end of the F-state distribution may respectively overlap portions of the Er state and G-state distributions, as illustrated in FIG. 6.

In various examples, the memory device may also or alternatively include memory cells of SLC, MLC, QLC, PLC or other types, or combinations thereof. These SLC, MLC, QLC, PLC WLs, or combinations may also be associated with respective programmed states, including respective highest and lowest states and highest and lowest portions of corresponding Vt distributions.

The schematic structural diagram 604 of FIG. 6 illustrates a block of one (1) NVM media 116. The diagram 604 is substantially similar to the diagram 310, and includes components and structures which are analogous, and function substantially similarly, to those described in connection with FIG. 4 above. Diagram 604 indicates a plurality of TLC memory cells in a group or WL with a box. During the read operation, Vread 614 is applied to the selected WL 612 indicated by the box. The adjusted Vpassr 616 is applied to one or more unselected WLs along the same selected BL 610 as the selected WL 612.

A default Vpassr may be established by a manufacturer or distributor of the example memory devices, for example by establishing a static default Vpassr for application to all unselected WLs of the blocks of the memory device during read operations. The static default Vpassr may be set so that it is higher than the high end of the distribution for the highest voltage programmed state of the corresponding memory cells (referred to as the “uppermost Vt”).

With reference to the Vt distributions of FIG. 6, a default Vpassr is illustrated at a higher voltage than an uppermost Vt for the G-state. The difference between the default Vpassr and the uppermost Vt is referred to as the “overdrive.” Because the distributions 606 of the upper programmed states shift left due to data retention effects, post-data retention effect distributions 608 increase the overdrive.

Various examples of the present disclosure include determining and applying an adjusted Vpassr to one or more unselected WLs to mitigate such data retention effects. For instance, a guard band may be initially defined as the difference between the manufacturer-set default Vpassr and the uppermost Vt of the highest programmed state (G-state) for a new, out-of-the-box memory device. For example, the guard band from the uppermost Vt distribution may cause the default Vpassr to be set at 7.2V.

Over time, upper Vt distributions 608 may experience a downward shift, such as a Vt down shift, due to data retention reduction. The overdrive after such data retention effects may correspondingly widen or increase, potentially causing read errors across multiple pages.

To address the issues around data retention effects, various examples of the present disclosure may continuously monitor and detect data retention temperatures for the block at a corresponding plurality of times (as described above) and use one or more of the data retention temperatures or their equivalents to compute an adjusted Vpassr. Shifts in the uppermost Vt distribution (i.e., from that associated with the distribution 606 to that associated with the Vt distribution 608) due to data retention effects may be monitored and identified based on one or more data retention temperatures. Based on this data retention shift, the default Vpassr may be adjusted. For instance, the default Vpassr of 7.2V may be reduced to an adjusted Vpassr of 7.15V based on a presumed downshift to the distribution 608. The degree of the presumed downshift may be computed or looked up using the plurality of data retention temperatures and the duration or time during which the corresponding block was at those temperatures, corresponding, e.g., to a presumed aggregate loss of electrons from charge traps of the memory cells. In turn, the guard band may be used to determine the adjusted Vpassr in conjunction with the degree of the presumed downshift.

For example, adjustments to the default Vpassr to identify or determine adjusted Vpassr(s), and/or corresponding shifts in Vt distributions for the uppermost state of the memory cells due to data retention effects, may be less than hundred (100) mV, less than eighty (80) mV, less than sixty (60) mV, less than forty (40) mV, or less than twenty (20) mV, without limitation. In various examples, Vread 614 is applied to the selected WL 612 during a read operation, and the adjusted Vpassr 616, another adjusted Vpassr, the default Vpassr, and/or any combination thereof, may be applied to the other unselected WLs of the block to perform the read operation. The adjusted Vpassr 616 may be lower than the default Vpassr.

In various examples, the adjusted Vpassr may be computed, determined or otherwise identified at any point in time of the plurality of corresponding times and/or in connection with receipt and/or performance of the read operation. This is because Vt distribution shifts from data retention effects (determined based on one or more data retention temperatures) can be identified at any time during the timelapse period between programming and read operations, including at regular intervals within the period, at the time of programming, at the time of the read operation, or any point in between, without limitation. Such intermittently determined shifts may be respectively associated with a corresponding interval of time during the timelapse period and aggregated to arrive at the adjusted Vpassr for application during the read operation.

However, in various examples, and as discussed in more detail above, the data retention temperatures (or averages thereof taken over multiple intervals and samples) may also or alternatively be stored for the timelapse period and the adjusted Vpassr computed, identified or otherwise determined following the timelapse period or otherwise in connection with performance of the read operation.

The data retention shift(s) and/or adjusted Vpassr may be determined based on predefined temperature characteristics, including maximum and minimum values, rates of change, fluctuations over time (e.g., derivative aspects of a temperature-time curve), or other relevant factors, without limitation. In this way, determination of the adjusted Vpassr may consider variables other than raw average temperature over the timelapse period, also as discussed in more detail above. In various examples, the adjusted Vpassr may be computed using a trained ML model or other predictive model, looked up in a lookup table, or otherwise determined within the scope of the present disclosure.

FIG. 7 illustrates an example method 700 for computing or identifying and applying an adjusted Vpassr to one or more WLs. The method 700 may be performed by a controller (e.g., the controller 106 and/or the Vpassr adjustment component 112 of FIG. 1) of a data storage system (e.g., the data storage system 104 of FIG. 1). The data storage system may additionally include a memory device (e.g., the memory device 114 of FIG. 1). The memory device may include a physical block (e.g., the block 310 of FIG. 4). The physical block may include a plurality of WLs (e.g., the WLs 402a, 402b, 402c, . . . 402n of FIG. 4) and a plurality of BLs (e.g., the BLs 404a, 404b, 404c, 404d, . . . 404n of FIG. 4). Each of the WLs may include a plurality of cells (e.g., the cells 406 of FIG. 4). In various examples, the memory device may include a virtual block and a sub-block of either the physical or virtual blocks. The method 700 may be applied to any physical, virtual, or sub-blocks within the data storage system, such as NAND flash memory. The data storage system may be connected to a host system (e.g., the host system 102 of FIG. 1).

At operation 702, a plurality of data retention temperatures may be identified at a plurality of corresponding times. In various examples, the plurality of data retention temperatures are measured, sampled or otherwise identified or determined over a timelapse period beginning with a program operation for a block and ending with a read operation for the block (discussed in more detail below).

A programming time and operating temperature (e.g., a first of the plurality of data retention temperatures) for the timelapse period may be identified, for example, in response to the host system's data write request. For instance, at programming time (t=0), data such as user data may be stored or written into various NAND blocks responsive to the write request, and the corresponding operating temperature at the time of or otherwise associated with the write operation may be twenty-five degrees Celsius (25° C.).

Operation 702 may include continuously or intermittently monitoring or sampling, and identifying one or more additional data retention temperatures for the block of the write operation. The monitoring or sampling may be at fixed or variable intervals. Accordingly, the plurality of corresponding times may be associated with the program or write operation, various intervals after the program operation, and a read operation. In other words, operation 702 may monitor and identify data retention temperatures over the timelapse period from the programming time up to the time of the read operation, inclusive, and at various regular or irregular intervals.

Further to the example given above: the data retention temperature recorded at t=0 may be twenty-five degrees Celsius (25° C.); at one hour (1 hr) after t=0, or t=1, the data retention temperature may be thirty-five degrees Celsius (35° C.); at two (2) hours after t=0, or t=2, the data retention temperature may be forty degrees Celsius (40° C.); and at two and a half hours (2.5 hr) after t=0, or t=2.5, the data retention temperature may be twenty degrees Celsius (20° C.), and so forth.

In various examples, at operation 702, various temperature characteristics may also be determined based on the data retention temperatures. These characteristics may include maximum and minimum values, rates of change, temporal fluctuations (such as derivative aspects of a temperature-time curve), or other relevant factors without limitation. In various examples, such temperature characteristics are determined periodically during the timelapse period based on subsets of the plurality of data retention temperatures, and/or at the end of the timelapse period based on the plurality of the data retention temperatures.

In various examples, the information discussed in more detail above may be stored in the memory device, for example, the local memory of the data storage system. For example, information such as the programming time and operating temperature (data retention temperature at t=0), and the remaining data retention temperatures of the data storage system along with the corresponding times (e.g., timestamps), may be stored within the memory device. In various examples, this information may be organized in a lookup table. In various examples, the data retention temperatures may be stored as aggregated, averaged, or accumulated values. For example, a running average may be stored in lieu of the raw data, such as where each WL is associated with a stored average temperature since iteratively computed at each temperature sampling interval, starting with the program operation. In various examples, an additional memory may be allocated for storing the temperature characteristics, including SDRAM, DDR, DMI, BRAM, eDMA, or SRAM, without limitation.

At operation 704, an adjusted Vpassr may be computed or determined based on the plurality of data retention temperatures. In various implementations, one or more data retention shift(s) may be determined based on the one or more data retention temperatures as discussed in more detail above. Accordingly, the default Vpassr may be adjusted in response to the data retention shift(s) to compute or otherwise determine the adjusted Vpassr. For example, a default Vpassr of 7.2V may be reduced to an adjusted Vpassr of 7.15V based on a fifty (50) mV downward shift of the uppermost Vt distribution of the uppermost state and maintenance of a substantially constant guard band. As noted previously, the adjustments to the default Vpassr may be less than hundred (100) mV, less than eighty (80) mV, less than sixty (60) mV, less than forty (40) mV, or less than twenty (20) mV, without limitation.

In various examples, also as discussed above, operation 704 may include determining a plurality of data retention shifts corresponding to intervals of the timelapse period. At any point in time between the programming time (t=0) and the read operation, a data retention shift may be determined for one or more intervals, or as a running total data retention shift. Further, the data retention shift(s) may be determined based on the various temperature characteristics.

In various examples, the adjusted Vpassr may be determined based directly on the data retention temperatures and timelapse period. For example, data retention temperatures and time characteristics (such as total length of time and average temperature, or a plurality of discrete pairs of temperature and time values) may be used to determine one or more adjustments to a Vpassr or an aggregate adjusted Vpassr.

The computation or determination of the adjusted Vpassr includes utilizing one of a lookup table, an equivalent operation, or a model (e.g., a ML model). For example, the adjusted Vpassr may be computed by referencing the lookup table, and/or applying aggregated, averaged, or accumulated temperature values, without limitation.

In various examples, trained ML, AI, or predictive models may be executed or applied to any of the aforementioned methods to compute the adjusted Vpassr. The trained models may also be used to apply the adjusted Vpassr to estimate or compute one or more additional adjusted Vpassr values for application to additional unselected WLs during the read operation, as discussed in more detail above. Also, or alternatively, additional adjusted Vpassr(s) may be computed or otherwise determined based on data retention temperature data substantially in the manner described herein.

At operation 706, the read operation using the adjusted Vpassr may be carried out. In various examples, the read operation may include applying Vread to the selected WL among a plurality of WLs and applying the adjusted Vpassr to one or more unselected WLs on the same BL as the selected WL. In various examples, the read operation may include applying the Vread to the selected WL and applying the adjusted Vpassr and/or the default Vpassr to the remaining one or more other unselected WLs. In various examples, the read operation may be performed by applying the Vread to the selected WL and one or more additional adjusted Vpassr values to the other unselected WLs in the plurality of WLs. In various examples, the default Vpassr and/or one or more additional adjusted Vpassr(s) may be applied alongside the adjusted Vpassr, in any combination.

Accordingly, the adjusted Vpassr may be applied to the one or more unselected WLs during the read operation to mitigate data retention effects, including in connection with the method 700 described herein.

### Feature Combinations

According to various examples of the present disclosure, a data storage system may include a memory device, a memory including instructions stored thereon, and at least one processor. The memory device may include a block that may include a plurality of wordlines (WLs). The memory may include instructions stored thereon that, when executed by the at least one processor, cause the at least one processor to: identify a plurality of data retention temperatures determined for the block at a plurality of corresponding times; compute an adjusted pass-through voltage (Vpassr) based on the plurality of data retention temperatures; and perform a read operation at least in part by: applying a read voltage (Vread) to a selected WL of the plurality of WLs; and applying the adjusted Vpassr to one or more unselected WLs of the plurality of WLs.

According to various examples of the present disclosure, a computer-implemented method may include: identifying a plurality of data retention temperatures determined for a block of a memory device of a data storage system at a plurality of corresponding times; computing an adjusted pass-through voltage (Vpassr) based on the plurality of data retention temperatures; and performing a read operation at least in part by: applying a read voltage (Vread) to a selected WL of a plurality of WLs of the block; and applying the adjusted Vpassr to one or more unselected WLs of the plurality of WLs.

According to various examples of the present disclosure, non-transitory computer readable media may have instructions stored thereon that, when executed by at least one processor, cause the at least one processor to: identify a plurality of data retention temperatures determined for a block at a plurality of corresponding times; compute an adjusted pass-through voltage (Vpassr) based on the plurality of data retention temperatures; and perform a read operation at least in part by: applying a read voltage (Vread) to a selected WL of a plurality of WLs of the block; and applying the adjusted Vpassr to one or more unselected WLs of the plurality of WLs.

In combination with any of the previous examples, the plurality of corresponding times may be associated with one or more of: time(s) within a timelapse period between a programming time and a time of the read operation; a plurality of regular intervals within a timelapse period between a programming time and a time of the read operation; a programming time; or a time of the read operation.

In combination with any of the previous examples, memory cells of the plurality of WLs may be configured with an uppermost programmed state associated with a distribution of Vt including an uppermost Vt distribution, and the computation of the adjusted Vpassr may include: determining, based on one or more of the plurality of data retention temperatures, a data retention shift of the uppermost Vt distribution, and adjusting a default Vpassr based on the data retention shift.

In combination with any of the previous examples, the data retention shift may correspond to one of the plurality of corresponding times, and the computation of the adjusted Vpassr may include determining a plurality of additional data retention shifts corresponding to additional ones of the plurality of corresponding times, wherein the adjusted Vpassr may be determined based on the data retention shift and the plurality of additional data retention shifts.

In combination with any of the previous examples, the computation of the adjusted Vpassr may include utilizing one of: a lookup table, or an equivalent operation.

In combination with any of the previous examples, at least one processor may be configured to: compute one or more additional Vpassr(s) based on the adjusted Vpassr, and apply the one or more additional Vpassr(s) to one or more other unselected WLs of the plurality of WLs to perform the read operation.

In combination with any of the previous examples, at least one processor may be configured to apply a default Vpassr to one or more other unselected WLs of the plurality of WLs to perform the read operation.

In combination with any of the previous examples, the adjusted Vpassr may be lower than a default Vpassr.

In combination with any of the previous examples, the computation of the adjusted Vpassr may be based on predefined temperature characteristics.

In combination with any of the previous examples, the computation of the adjusted Vpassr may include one of: (i) aggregating a plurality of voltage adjustments corresponding to a plurality of intervals over a timelapse period between a programming time and a time of the read operation, or (ii) computing a total voltage adjustment over a timelapse period between a programming time and a time of the read operation.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the disclosure has been described with reference to the embodiments illustrated in the attached drawing figures, it is noted that equivalents may be employed and substitutions made herein without departing from the scope of the disclosure as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A data storage system comprising:
a memory device including a block, the block including a plurality of wordlines (WLs);
non-transitory computer readable media storing instructions thereon; and
at least one processor, wherein the instructions, when executed by the at least one processor, cause the at least one processor to:
identify a plurality of data retention temperatures determined for the block at a plurality of corresponding times;
compute an adjusted pass-through voltage (Vpassr) based on the plurality of data retention temperatures; and
perform a read operation at least in part by—
applying a read voltage (Vread) to a selected WL of the plurality of WLs,
applying the adjusted Vpassr to one or more unselected WLs of the plurality of WLs.

2. The data storage system of claim 1, wherein the plurality of corresponding times is associated with one or more of: time(s) within a timelapse period between a programming time and a time of the read operation; a plurality of regular intervals within a timelapse period between a programming time and a time of the read operation; a programming time; or a time of the read operation.

3. The data storage system of claim 1, wherein memory cells of the plurality of WLs are configured with an uppermost programming state associated with a distribution of threshold voltages including an uppermost threshold voltage, and wherein the computation of the adjusted Vpassr includes:
determining, based on one or more of the plurality of data retention temperatures, a data retention shift of the uppermost threshold voltage, and
adjusting a default Vpassr based on the data retention shift.

4. The data storage system of claim 3, wherein the data retention shift corresponds to one of the plurality of corresponding times, and wherein the computation of the adjusted Vpassr includes determining a plurality of additional data retention shifts corresponding to additional ones of the plurality of corresponding times, the adjusted Vpassr being determined based on the data retention shift and the plurality of additional data retention shifts.

5. The data storage system of claim 1, wherein the computation of the adjusted Vpassr includes utilizing one of: a lookup table, or an equivalent operation.

6. The data storage system of claim 1, wherein the at least one processor is further configured to:
compute one or more additional Vpassr(s) based on the adjusted Vpassr, and
apply the one or more additional Vpassr(s) to one or more other unselected WLs of the plurality of WLs to perform the read operation.

7. The data storage system of claim 1, wherein the at least one processor is further configured to apply a default Vpassr to one or more other unselected WLs of the plurality of WLs to perform the read operation.

8. The data storage system of claim 1, wherein the adjusted Vpassr is lower than a default Vpassr.

9. The data storage system of claim 1, wherein the computation of the adjusted Vpassr is based on predefined temperature characteristics.

10. The data storage system of claim 1, wherein the computation of the adjusted Vpassr includes one of: (i) aggregating a plurality of voltage adjustments corresponding to a plurality of intervals over a timelapse period between a programming time and a time of the read operation, or (ii) computing a total voltage adjustment over a timelapse period between a programming time and a time of the read operation.

11. A computer-implemented method, comprising:
identifying a plurality of data retention temperatures determined for a block of a memory device of a data storage system at a plurality of corresponding times, the block including a plurality of wordlines (WLs);
computing an adjusted pass-through voltage (Vpassr) based on the plurality of data retention temperatures; and
performing a read operation at least in part by—
applying a read voltage (Vread) to a selected WL of the plurality of WLs,
applying the adjusted Vpassr to one or more unselected WLs of the plurality of WLs.

12. The computer-implemented method of claim 11, wherein the plurality of corresponding times is associated with one or more of: time(s) within a timelapse period between a programming time and a time of the read operation; a plurality of regular intervals within a timelapse period between a programming time and a time of the read operation; a programming time; or a time of the read operation.

13. The computer-implemented method claim 11, wherein memory cells of the plurality of WLs are configured with an uppermost programming state associated with a distribution of threshold voltages including an uppermost threshold voltage, and wherein the computation of the adjusted Vpassr includes:
determining, based on one or more of the plurality of data retention temperatures, a data retention shift of the uppermost threshold voltage, and
adjusting a default Vpassr based on the data retention shift.

14. The computer-implemented of claim 13, wherein the data retention shift corresponds to one of the plurality of corresponding times, and wherein the computation of the adjusted Vpassr includes determining a plurality of additional data retention shifts corresponding to additional ones of the plurality of corresponding times, the adjusted Vpassr being determined based on the data retention shift and the plurality of additional data retention shifts.

15. The computer-implemented method of claim 11, wherein the computation of the adjusted Vpassr includes utilizing one of: a lookup table, or an equivalent operation.

16. The computer-implemented method of claim 11, further comprising:
computing one or more additional Vpassr(s) based on the adjusted Vpassr, and
applying the one or more additional Vpassr(s) to one or more other unselected WLs of the plurality of WLs to perform the read operation.

17. The computer-implemented method of claim 11, further comprising applying a default Vpassr to one or more other unselected WLs of the plurality of WLs to perform the read operation.

18. The computer-implemented method of claim 11, wherein the adjusted Vpassr is lower than a default Vpassr.

19. The computer-implemented method of claim 11, wherein the computation of the adjusted Vpassr is based on predefined temperature characteristics.

20. The computer-implemented method of claim 11, wherein the computation of the adjusted Vpassr includes one of: (i) aggregating a plurality of voltage adjustments corresponding to a plurality of intervals over a timelapse period between a programming time and a time of the read operation, or (ii) computing a total voltage adjustment over a timelapse period between a programming time and a time of the read operation.
